(19) United States
(12) Patent Application Publication
(10) Pub. No.: US 2011/0125764 A1
(43) Pub. Date: May 26, 2011

(54) METHOD AND SYSTEM FOR IMPROVED QUERY EXPANSION IN FACETED SEARCH

(75) Inventors: David Carmel, Haifa (IL); Nadav Har'El, Haifa (IL); Haggai Roitman, Qiryat-Ata (IL)

(73) Assignee: International Business Machines Corporation, Armonk, NY (US)

(21) Appl. No.: 12/626,642

(22) Filed: Nov. 26, 2009

(51) Int. Cl. G06F 17/30

(52) U.S. Cl. 707/749; 707/779; 707/E17.008; 707/E17.014

(57) ABSTRACT

A method and system for improved query expansion in faceted search are provided. The method includes: receiving a search query; expanding the search query to obtain query expansion terms; and receiving a facet selection for the search query. A facet profile is retrieved in the form of collected important terms for the facet; and the query expansion terms are weighted by comparing them to the facet profile. The query expansion terms are re-ranked and the method includes executing the re-weighted query expansion terms whilst filtering for the facet.

### FIELD OF THE INVENTION

This invention relates to the field of information retrieval. In particular, the invention relates to improved query expansion in faceted search.

### BACKGROUND OF THE INVENTION

Information retrieval offers two main search approaches:
Navigational Search uses a hierarchy structure (taxonomy) to enable users to browse the information space by iteratively narrowing the scope of their quest in a predetermined order, as exemplified by Yahoo! Directory (Yahoo! is a trade mark of Yahoo! Inc.), DMOZ Open Directory Project (DMOZ is a trade mark of Netscape Communications), etc.
Direct Search allows users to simply write their queries as a bag of words in a text box. This approach has been made enormously popular by Web search engines, such as Google (Google is a trade mark of Google Inc.) and Yahoo! Search solutions.

Neither direct search nor navigational search adequately addresses the information access problem. Direct search against a collection of records appeals to users by offering the simplicity of a text box, but offers no facility for query refinement when searches return unsatisfying results. Navigational search provides guidance through the use of a hierarchical taxonomy, but results in a limited user experience—particularly for information spaces whose records do not have a natural hierarchical organization.

Faceted search aims to combine navigational and direct search to leverage the best of both approaches. Faceted search has become the prevailing user interaction mechanism in e-commerce sites and is being extended to deal with semi-structured data, continuous dimensions, and folksonomies.

In a typical faceted search interface, users start by entering a query into a search box. The system uses this query to perform a full-text search, and then offers navigational refinement on the results of that search. At any step in the search session the user may do one of:
modify the search query;
browse (drill-down) into one of several displayed facets that further narrow the context of the current query, or
remove some facets from the context (roll-up), hence generalizing the context.
   Note that when narrowing a query by drilling down into a facet, search results are filtered to contain only those documents associated with the facet. The new list of search results is a sub-list of the original search results, since the selected facets are used for filtering.

There are numerous approaches for query expansion. The most successful one is based on the user's relevance feedback. Given a set of documents, R, marked as relevant for the query by the searcher, and a set of documents, N, marked as irrelevant, then the query can be expanded, for example using the Rocchio formula from J. J. Rocchio—“The SMART retrieval system: experiments in information retrieval”, 1971:

q′=alpha*q+beta*1/|R|*sum_{—}{r in R}r−gamma*1\|N|sum_{—}{n in N}n

The drawback of this approach is that users do not tend to provide feedback, hence many techniques have been suggested to replace the user's feedback, including pseudo-relevance feedback, and many others. Unfortunately, none of these approaches is able to achieve the same effectiveness as direct relevant feedback expansion approach.

### SUMMARY OF THE INVENTION

According to a first aspect of the present invention there is provided a method for improved query expansion in faceted search, comprising: receiving a search query; expanding the search query to obtain query expansion terms; receiving a facet selection for the search query; retrieving a facet profile in the form of collected important terms for the facet; and re-weighting the query expansion terms by comparing them to the facet profile; wherein said steps are implemented in either: a) computer hardware configured to perform said identifying, tracing, and providing steps, or b) computer software embodied in a non-transitory, tangible, computer-readable storage medium.

According to a second aspect of the present invention there is provided a method for weighting query expansion terms, comprising: obtaining query expansion terms for a search query; obtaining a facet profile in the form of collected important terms for a facet selected for the search query; and weighting the query expansion terms by comparing them to the facet profile; wherein said steps are implemented in either: a) computer hardware configured to perform said identifying, tracing, and providing steps, or b) computer software embodied in a non-transitory, tangible, computer-readable storage medium.

According to a third aspect of the present invention there is provided a computer program product for weighting query expansion terms, the computer program product comprising: a computer readable medium; computer program instructions operative to: obtain query expansion terms for a search query; obtain a facet profile in the form of collected important terms for a facet selected for the search query; and weight the query expansion terms by comparing them to the facet profile; wherein said program instructions are stored on said computer readable medium.

According to a fourth aspect of the present invention there is provided a system for improved query expansion in faceted search, comprising: a faceted search engine including a query input means and a filter for filtering to a selected facet; a query expansion module for providing query expansion terms; a query expansion enhancer module for re-weighting the query expansion terms by comparing the query expansion terms to a facet profile in the form of collected important terms for a selected facet; wherein any of said faceted search engine, query expansion module, and query expansion enhancer module are implemented in either of computer hardware or computer software and embodied in a non-transitory, tangible, computer-readable storage medium.

According to a fifth aspect of the present invention there is provided a method of providing a service to a customer over a network for improved query expansion in faceted search, the service comprising: obtain query expansion terms for a search query; obtain a facet profile in the form of collected important terms for a facet selected for the search query; and weight the query expansion terms by comparing them to the facet profile; wherein said steps are implemented in either: a) computer hardware configured to perform said identifying, tracing, and providing steps, or b) computer software embodied in a non-transitory, tangible, computer-readable storage medium.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a block diagram of a computer system in which the present invention may be implemented;

FIG. 3 is a flow diagram of a method in accordance with an aspect of the present invention;

FIG. 4 is a flow diagram of a method in accordance with another aspect of the present invention; and

FIG. 5 is a schematic representation of results of a system in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and system are described for improved query expansion using input from faceted search navigation. By selecting a specific facet, a user provides a feedback for the search engine about his information needs. This feedback can be exploited for search enhancement using query expansion methods.

The explicit user feedback provided by a user selecting a specific facet for drilling down is used to expand a query appropriately to enhance the effectiveness of faceted search. Integrating query expansion into faceted search improves the search results compared to the baseline of faceted search without query expansion.

The query is expanded during faceted search by utilizing the user feedback, as reflected by the facet the user chose to drill down. This is enabled by representing each facet as a distribution over the vocabulary space of terms and holding this information in the search index. During the search, given a query q, and a facet F selected by the user, the query is first expanded by any query expansion method to receive a set of candidate terms T for expansion. Each of those terms is then weighted according to its relations with the selected facet F profile terms. Then, the query q is expanded by the highly weighted candidate terms, or alternatively, by all those terms which are boosted according to their relationship strength with F.

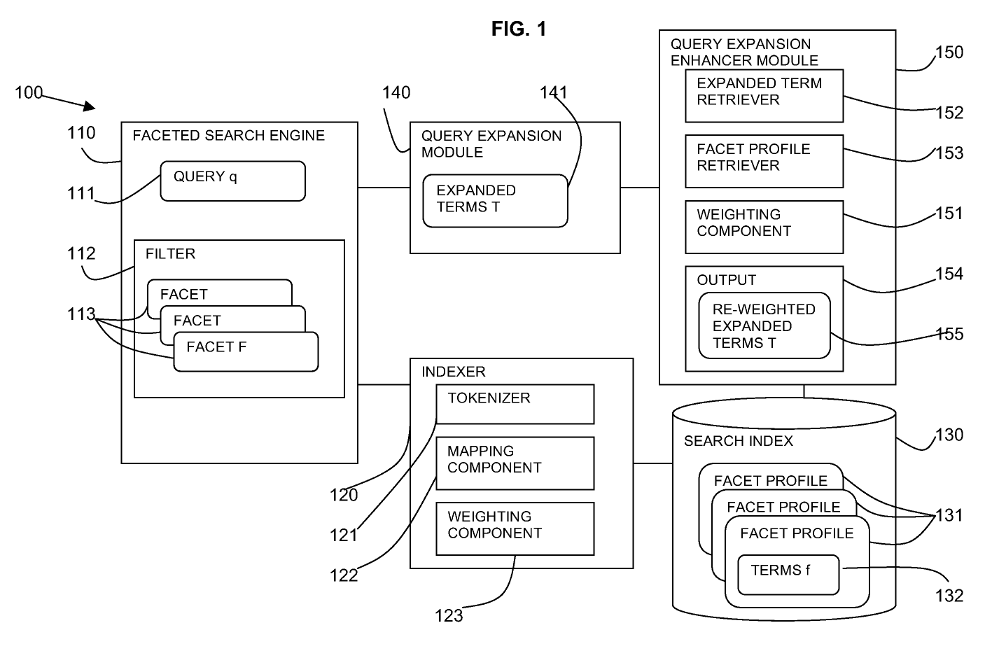

Referring to FIG. 1, a search system 100 is shown including a faceted search engine 110 in which a query 111 is input by a user. The query 111 may be formed of one or more keywords or terms.

Faceted search, also called faceted navigation or faceted browsing, is a technique for accessing a collection of information represented using a faceted classification, allowing users to explore by filtering available information. A faceted classification system allows the assignment of multiple classifications to an object such as a document, enabling the classifications to be ordered in multiple ways, rather than in a single, pre-determined, taxonomic order. Each facet typically corresponds to the possible values of a property common to a set of digital objects.

A faceted search engine 110 includes a filter 112 for filtering returned documents by facets F 113. In the described system, a facet profile 131 is introduced.

In an indexing stage, an indexer 120 creates facet profiles 131. The indexer 120 includes a tokenizer 121 for tokenizing facet documents, a mapping component 122 for mapping the token terms to facets, and a weighting component 123 for weighting each token term.

Each indexed document may have zero to many facets. Given a specific facet F, only those documents that contain that facet are considered. The token terms relevant to that facet F are terms that appear in those documents.

The indexer 120 extracts the most important terms 132 that represent the facet F 113. A facet profile is constructed from the most important terms, while each term is associated with its relevant importance weight. The facet profile 131 is stored in a search index 130. In one embodiment, the facet label keywords may also be included in the facet profile.

In one example embodiment, the facet profile 131 may be stored as a posting list per facet which maps each facet to its terms. Terms 132 may be kept in a decreasing order of their relevance to the facet 113.

A query expansion module 140 is used which may use any form of known query expansion methods. The query expansion module 140 provides suggested query expansion terms 141 for a given query q 111.

The described system includes a query expansion enhancer module 150. The enhancer module 150 may be integrated with the query expansion module 140 or may be an add-on service.

The enhancer module 150 includes a query expansion term retriever 152 for obtaining the query expansion terms t 141 from the query expansion module 140 and a facet profile retriever 153 for obtaining the facet profile terms f 132 from the search index 130 for a selected facet 113 in the faceted search engine 110.

The query expansion enhancer module 150 includes a weighting component 151 which weights the query expansion terms t 141 by comparing them to the facet profile F 132 for the selected facet 113 in the faceted search engine 110. The weighting component 151 of the enhancer module 150 re-weights the query expansion terms t 141 and outputs re-weighted query expansion terms t 155.

The comparing method used in the weighting component 151 of the enhancer module 150 can use any semantic relatedness method. In one embodiment, this re-weighting can be carried out according to weighted average pointwise mutual information (PMI). An output 154 outputs the re-weighted query expansion terms t 155.

The re-weighted query expansion terms t 155 are then used to expand the query q 111. The expanded query is then executed by the faceted search engine whilst also applying the document filtering according to the user selected facet F 113.

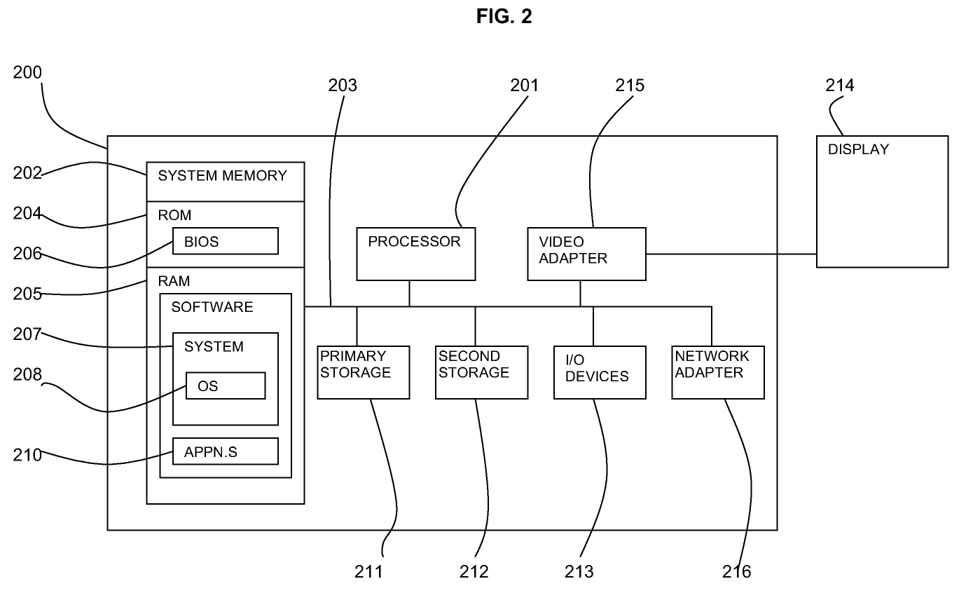

Referring to FIG. 2, an exemplary system for implementing aspects of the invention includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

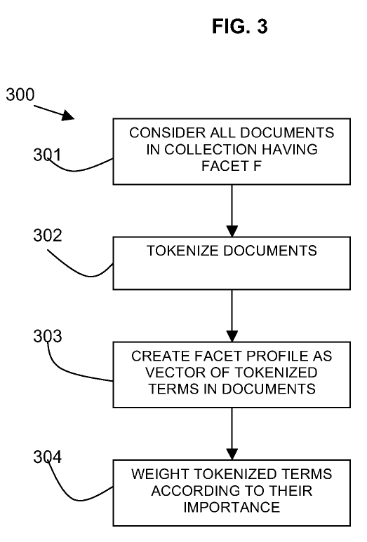

Referring to FIG. 3, a flow diagram 300 shows a method of creating facet profiles during indexing. A facet profile is generated, by considering 301 all documents in the collection that include facet F. The documents are tokenized 302 to extract token terms of importance in the documents. A facet profile is created 303 as a vector of the terms that appear in those documents (for example, a profile that represents the centroid of the documents of the facet). Different terms in the facet profile (vector) are selected and weighted 304 according to their importance in representing that facet using feature extraction methods.

Each facet is represented by extracting the most important terms that represent it. Important terms extraction can be done by any feature selection method, including for example, the Jensen-Shannon divergence (JSD) method of measuring the distance between two probability distributions that looks for a set of terms that best separates between the facet documents to the entire collection. Each term in the vocabulary will then be weighted according to its contribution to the JSD distance score of the set of the facet documents from the collection (David Carmel, Elad Yom-Tov, Adam Darlow, Dan Pelleg: What makes a query difficult?. SIGIR 2006: 390-397). The facet's weight distribution (profile) is kept in the search index to enable efficient term selection for facet-based query expansion.

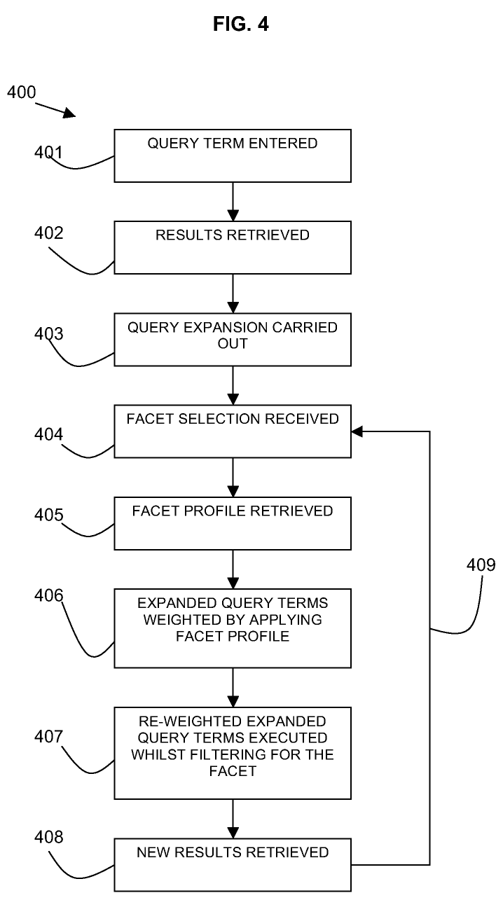

Referring to FIG. 4, a flow diagram 400 shows a method of searching using the improved query expansion. A query term is entered 401 and results retrieved 402. A query expansion is carried out 403 to expand the query terms. A facet selection is received 404 and a facet profile is retrieved 405. The expanded query terms are weighted 406 by comparing the facet profile to the expanded query terms. The re-weighted expanded query is then executed 407 whilst filtering results to the given facet. The new results are returned 408.

As faceted search is being used, the process of query expansion can be re-applied for any other facet the user selects during facet drill-down operations. Therefore, the method may loop 409 from the step of retrieving results 408 to a further facet selection 404.

Facet-based query expansion is carried out as follows. Given a query q={q₁ . . . qₙ}, a facet F, selected by the user for drilling down, and a set of terms T={t₁ . . . tₖ} to be used for expansion. It is assumed that the set of terms for expansion are provided by any query expansion technique, for example, from an external knowledge base such as WordNet (a lexical database for the English language which groups words into sets of synonyms, provides short definitions, and records semantic relation between the synonym sets) or the Web, or by pseudo-relevance feedback methods.

The re-weighting process of expansion terms uses a semantic relatedness method. In one embodiment, pointwise mutual information (PMI) is used, where the PMI of a pair of discrete random variables quantifies the discrepancy between the probability of their coincidence given their joint distribution versus the probability of their coincidence given only their individual distributions and assuming independence.

The expansion process can be summarized as follows: weight each term tᵢ in T, according to its (weighted) average pointwise mutual information with all facet F profile terms:

PMI(F,tᵢ)=1/|F|*Sum_{fj}w(f^{j})*PMI(fⱼ,tᵢ)

where w(fⱼ) is the relative weight of term fⱼ in facet F profile, and PMI(fⱼ, tᵢ) is the pointwise mutual information between term fⱼ in facet F profile and expanded term tᵢ and |F| is the number of terms in facet F profile.

The pointwise mutual information between two terms PMI(f, tᵢ) is measured as follows:

PMI(f_{f},tᵢ)=log(Pr(fⱼ,tᵢ|Collection)/Pr(fⱼ|Collection)*Pr(tᵢ|Collection))

and Pr(x|Collection), the probability of finding x in the collection, can be approximated by maximum likelihood estimation:

Pr(x|Collection)=#(x|Collection)/#(Collection)

where (#x|Collection) stands for the number of occurrences of the term x in the collection, and #(Collection) stands for the number of terms in the collection.

In another embodiment, alternative semantic relatedness methods may be used, for example, Evgeniy Gabrilovich's semantic relatedness measure between terms over Wikipedia (Wikipedia is a trade mark of Wikipedia Foundation, Inc.) concept space (Evgeniy Gabrilovich, Shaul Markovitch: Computing Semantic Relatedness Using Wikipedia-based Explicit Semantic Analysis. IJCAI 2007: 1606-1611).

The query is expanded with the maximal weighted terms, for example, all terms with a weight higher than a given threshold. A boost is given to each expanded term in the expanded query according to its relative weight.

The expanded query is executed while filtering out all documents not belonging to F.

In summary, each facet is represented by a vector of terms (f1 . . . fn), computed at indexing time. Given a facet F selected by the user, each candidate term for expansion, tᵢ, is weighted by its average relative semantic relatedness with all terms in F.

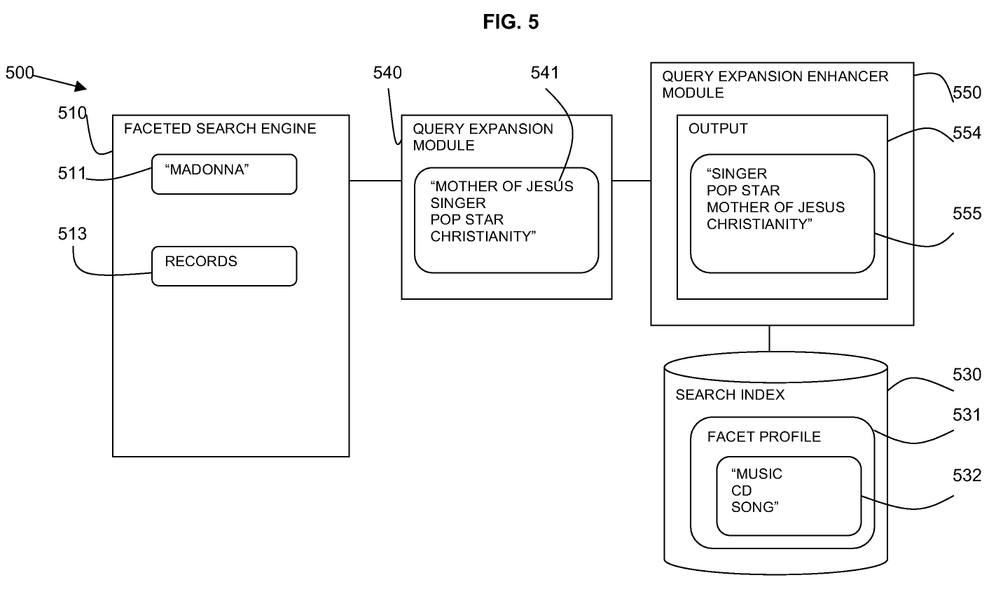

A worked example is described with reference to FIG. 5 which shows a schematic representation of the system and process. A user has entered the query “Madonna” 511 in a faceted search engine 510. A query expansion 540 has expanded the query using the terms 541: “Mother of Jesus”, “Singer”, “Pop Star”, and “Christianity”.

A user select the facet “Records” 513 in the search engine 510. The previously indexed profile 531 of the facet “Records” 513 in the search index 530 contains the following top-three representative terms 532: [“Music”, “CD”, “Song”].

Using the described method, the expanded terms 541 are ranked based on the user facet selection. This is done by measuring the semantic relatedness between the facet profile 531 and each of the expanded terms 541. The query expansion enhancer module 550 outputs 554 the re-ranked expanded query terms 555 for use in the search engine 510 with the facet selection of “Records” 513.

Applying this measure on the expanded terms 541 it is clear that the terms “Singer” and “Pop Star” would be ranked higher as the expanded terms for the query, since the profile terms match better with those words than with those in the context of Christianity. The original query “Madonna” will then be expanded with the terms “singer” and “pop star” that are semantically related to the feedback facet “Records”.

Therefore, the suggested method provides means of explicit feedback for query expansion while utilising the explicit user feedback as realized by his selected facet, compared to many existing query expansion techniques that rely on pseudo feedback in which the context is implicitly inferred from the data.

In regular faceted search session, the user can only filter out the initial search result, where the scope of relevant documents does not change and the user can only reduce the documents while navigating the facets. This in turn can leave the user with no relevant documents in the end of the session, and requiring the user to manually expand his initial query in order to restart the faceted navigation towards his goal.

The described method and system increase the recall using query expansion based on the feedback of selected facet. Therefore, while the user may not find relevant documents using the initial query (in the example “Madonna”), it is likely that the expanded query (“Singer” or/and “Pop Star”) will help the user to find the relevant documents during the faceted navigation.

The provision of a facet profile in which words relating to a facet are provided can be used to provide explicit feedback to a query. The drill-down options are not themselves ambiguous like added words often are, so they are more likely to improve the expansion, rather then risk adding more irrelevant expansions as words can add. Also, drill-down categories are available in addition to the words the user types, and therefore provide useful information which is utilised by the described method and system.

It is well known that query expansion hurts search because it improves recall at the cost of hurting precision. The described method and system provide a way in which faceted search is not hurt by query expansion, as added expanding terms are strongly related to the target facet, therefore giving the benefits of both faceted search (allowing easy navigation) and query expansion (improving recall).

The concept of maintaining facet profiles (in the form of a weighted mapping between facets to their important terms) is introduced. Facet profiles provide a flexible way in which user facet selection can be utilised as a feedback to reweigh candidate terms/concepts for query expansion.

The described method and system are built on top of any existing query expansion solution which recommends terms for expansion and provide an efficient way using facet profiles in which different candidate terms/concepts can be reweighed according to the user feedback signal generated during the faceted navigation of the user.

The described method and system does not assume any restriction on the origin or number of candidate terms/concepts for expansion. Any set of terms proposed by several query expansion methods at the same time may be used. The method takes such candidate terms and reweighs them with respect to the feedback signal generated by the user facet selection.

The query is expanded only with terms that are strongly related to the selected facet. This type of expansion is expected to reduce the well known query drift problem of expansion methods which expand the query with terms that represent different aspects of the original query, thus, “drifts” the query form the original user's intent. Since the user selected the facet explicitly, it is more likely that the expanded terms relates to the aspect he is looking for.

Compared to standard facet search, in which the pruned set of results after drilling down is a subset of the result set before the drill, in the described approach, other relevant results might be retrieved belonging to the selected facet that were not retrieved before expansion.

Ranking of the search results is modified according to the expanded query which better expresses the user intent.

An improved query expansion system may be provided as a service to a customer over a network.

The invention can take the form of an entirely hardware embodiment, or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for improved query expansion in faceted search, comprising:
receiving a search query;
expanding the search query to obtain query expansion terms;
receiving a facet selection for the search query;
retrieving a facet profile in the form of collected important terms for the facet; and
weighting the query expansion terms by comparing them to the facet profile;
wherein said steps are implemented in either:
a) computer hardware configured to perform said identifying, tracing, and providing steps, or
b) computer software embodied in a non-transitory, tangible, computer-readable storage medium.

2. The method as claimed in claim 1, including:
executing the re-weighted query expansion terms whilst filtering for the facet.

3. The method as claimed in claim 1, wherein an explicit user feedback of facet selection is used to better select the query expansion terms.

4. The method as claimed in claim 1, wherein an existing query expansion method is used to obtain the query expansion terms.

5. The method as claimed in claim 1, wherein weighting the query expansion terms uses a semantic relatedness method to compare the query expansion terms to terms in the facet profile.

6. The method as claimed in claim 1, including:
creating a facet profile by extracting terms from a set of facet documents by a feature selection method.

7. The method as claimed in claim 1, wherein a facet profile is a weighted mapping between facets and important collected terms.

8. The method as claimed in claim 1, wherein the query expansion terms are generated by one or more query expansion methods.

9. A method for weighting query expansion terms, comprising:
obtaining query expansion terms for a search query;
obtaining a facet profile in the form of collected important terms for a facet selected for the search query; and
weighting the query expansion terms by comparing them to the facet profile;
wherein said steps are implemented in either:
a) computer hardware configured to perform said identifying, tracing, and providing steps, or
b) computer software embodied in a non-transitory, tangible, computer-readable storage medium.

10. A computer program product for improved query expansion in faceted search, the computer program product comprising:
a computer readable medium;
computer program instructions operative to:
obtain query expansion terms for a search query;
obtain a facet profile in the form of collected important terms for a facet selected for the search query; and
weight the query expansion terms by comparing them to the facet profile;
wherein said program instructions are stored on said computer readable medium.

11. A system for improved query expansion in faceted search, comprising:
a faceted search engine including a query input means and a filter for filtering to a selected facet;
a query expansion module for providing query expansion terms;
a query expansion enhancer module for weighting the query expansion terms by comparing the query expansion terms to a facet profile in the form of collected important terms for a selected facet;
wherein any of said faceted search engine, query expansion module, and query expansion enhancer module are implemented in either of computer hardware or computer software and embodied in a non-transitory, tangible, computer-readable storage medium.

12. The system as claimed in claim 11, wherein the faceted search engine executes re-weighted query expansion terms whilst filtering for a selected facet.

13. The system as claimed in claim 11, wherein the query expansion module uses one or more known query expansion methods.

14. The system as claimed in claim 11, wherein the query expansion module and the query expansion enhancer module are an integrated component.

15. The system as claimed in claim 11, wherein the query expansion enhancer module is an add-on component to an existing query expansion module.

16. The system as claimed in claim 11, including an indexer for creating a facet profile by extracting terms from a set of facet documents by a feature selection method.

17. The system as claimed in claim 11, wherein a facet profile is a weighted mapping between facets and important collected terms.

18. The system as claimed in claim 11, wherein the query expansion enhancer module includes:
a query expansion term retriever for retrieving query expansion terms from a query expansion module;
a facet profile retriever for retrieving a facet profile for a selected facet from an index;
and
a weighting component for weighting the query expansion terms using a semantic relatedness method to compare the query expansion terms to terms in the facet profile.
